(19) United States
(12) Patent Application Publication
(10) Pub. No.: US 2026/0255002 A1
(43) Pub. Date: Aug. 27, 2026

(54) METHOD FOR SUPPORTING PLAYBACK CONTROL OF MULTI-SCREEN VIDEO AND SYSTEM THEREFOR

(71) Applicant: CJ 4DPLEX CO., LTD., Seoul (KR)

(72) Inventors: Kyoung Hwan KIM, Seoul (KR); Yo Seph CHOI, Seoul (KR); Seong Pil HYUN, Seoul (KR); Dae Hyun WI, Seoul (KR); Bum Ki KIM, Seoul (KR); Seung Hwa JEONG, Seoul (KR)

(21) Appl. No.: 19/650,214

(22) Filed: Apr. 16, 2026

Related U.S. Application Data
(63) Continuation of application No. PCT/KR2024/017361, filed on Nov. 6, 2024.

(30) Foreign Application Priority Data
Nov. 8, 2023 (KR) 10-2023-0153356

(51) Int. Cl. H04N 21/2187; H04N 9/31; H04N 21/214; H04N 21/431; H04N 21/472

(52) U.S. Cl. CPC H04N 21/2187; H04N 21/2143; H04N 21/4316; H04N 21/47205; H04N 9/3147

(57) ABSTRACT

The present invention relates to a method and system for supporting the playback control of multi-screen videos. Specifically, the present invention relates to a method and system that support the playback control of multi-screen video content when an administrator (user) wishes to play back movie content or live content in a multi-screen theater equipped with multiple projection surfaces.

### CROSS REFERENCE TO RELATED APPLICATION(S)

This application is a continuation application under 35 U.S.C. 120, claiming a priority and benefit of International Application No. PCT/KR2024/017361 filed on Nov. 6, 2024, claiming priority based on Korean Patent Application No. 10-2023-0153356 filed on Nov. 8, 2023, the disclosure of which are incorporated herein by reference in their entirety.

### TECHNICAL FIELD

The present invention relates to a method and system for supporting the playback control of multi-screen videos. Specifically, the present invention relates to a method and system that support the playback control of multi-screen video content when an administrator (user) wishes to play back movie content or live content in a multi-screen theater equipped with multiple projection surfaces.

### BACKGROUND ART

To enhance the audience's immersion and provide a more novel theater experience, theaters equipped with multiple projection surfaces are being designed, and these so-called multi-screen theaters are attracting attention from many audiences.

Meanwhile, recent movie theaters are not only playing back movie content but are also attracting audiences by offering services that stream live event footage in real time.

As interest in multi-screen theaters increases and the types of content that can be played back in such multi-screen theaters diversify, the task of controlling the playback of multi-screen video content in these multi-screen theaters is becoming increasingly complex. While administrators who manage these multi-screen theaters are trained to handle control tasks, there is still a demand for making the complex process of controlling the playback of multi-screen video content more intuitive and easier to manage.

The present invention has been proposed in light of these issues, with the aim of providing an environment that allows an administrator (user) to easily control the playback of multi-screen video content.

### DISCLOSURE

### Technical Problem

Therefore, an object of the present invention is to support a user, i.e. an administrator, in easily controlling the playback of multi-screen video content in a multi-screen theater equipped with multiple projection surfaces.

In particular, another object of the present invention is to improve the quality of theater services, which could lead to severe consequences in the event of operational errors, and to enhance user convenience by providing user interfaces that can be intuitively understood and interacted with by a user.

Still another object of the present invention is to enhance user convenience by providing user interfaces for controlling the playback of live content.

Still yet another object of the present invention is to provide a user with a management interface that can be used to test the overall operational status of a theater server and internal devices in a theater.

Meanwhile, the above-mentioned objects of the present invention are not limited to those mentioned above, and other objects not mentioned will be clearly understood by those skilled in the art from the following description.

### Technical Solution

To solve the aforementioned issues, an embodiment of the present invention provides a method for supporting the playback control of multi-screen videos by a theater server in a multi-screen theater including multiple projection surfaces, the method including a step of providing a first interface for multi-screen video playback control to a user, wherein the first interface may include: a title area for displaying the title of multi-screen video content that is currently being played or scheduled to be played; a projection device control area for controlling multiple projection devices provided in the multi-screen theater; a content area for displaying at least one piece of content that can be played back in the multi-screen theater; and a server control area that allows control of at least one server connected to the theater server.

Moreover, according to the method for supporting the playback control of multi-screen videos, the projection device control area may include: a display indicating a main projection surface and multiple sub-projection surfaces; and a display indicating the seating arrangement in the multi-screen theater.

Furthermore, according to the method for supporting the playback control of multi-screen videos, the multi-screen video content displayed by the theater server may be played back in cue screening mode or manual screening mode.

In addition, the method for supporting the playback control of multi-screen videos may further include, if the multi-screen video content is played back in manual screening mode by the theater server, a step of receiving a new content creation start input from the user through the first interface; a step of setting playback options of the main projection surface within the multi-screen theater; a step of setting the content to be projected on the sub-projection surfaces within the multi-screen theater; and a step of creating new content.

Another embodiment of the present invention provides a method for supporting the playback control of live content videos by a theater server in a multi-screen theater including multiple projection surfaces, the method including a step of providing a second interface for live content video playback control to a user, wherein the second interface may include: a video monitoring area for monitoring a live content video; a log information area for displaying relevant logs when the live content video is played back in the multi-screen theater; and a live content path input area for inputting a live content path.

Moreover, according to the method for supporting the playback control of live content videos, the second interface may further include an additional video monitoring area for monitoring whether the live content video is being output normally across the multiple projection surfaces within the multi-screen theater.

Furthermore, according to the method for supporting the playback control of live content videos, the live content video may be obtained from live content video data received by the theater server from any content server, and the live content video data may be a composite video composed of multiple videos corresponding to each projection surface within the multi-screen theater.

In addition, according to the method for supporting the playback control of live content videos, the second interface may further include an image area for displaying a specific image that is output separately from the live content video within the multi-screen theater.

Moreover, according to the method for supporting the playback control of live content videos, the specific image may be an advertising image or a notification image that is output on a specific projection surface within the multi-screen theater or in an area other than the projection surface.

Furthermore, according to the method for supporting the playback control of live content videos, the second interface may further include an image path input area for inputting the path of the specific image.

In addition, according to the method for supporting the playback control of live content videos, the live content video displayed by the theater server may be played back in any one of automatic loading playback mode, cue playback mode, or manual playback mode.

Additionally, the method for supporting the playback control of live content videos may further include, if the live content video is played back in manual playback mode by the theater server, a step of receiving a live content start input from the user through the second interface; and a step of setting the path of the live content video to be played back in the multi-screen theater.

Still another embodiment of the present invention provides a theater server for supporting the playback control of multi-screen videos, the theater server including a central processing unit and a memory, wherein the central processing unit may execute instructions stored in the memory for performing a method for supporting the playback control of multi-screen videos, wherein the method for supporting the playback control of multi-screen videos may include a step of providing a first interface for multi-screen video playback control to a user, wherein the first interface may include: a title area for displaying the title of multi-screen video content that is currently being played or scheduled to be played; a projection device control area for controlling multiple projection devices provided in the multi-screen theater; a content area for displaying at least one piece of content that can be played back in the multi-screen theater; and a server control area that allows control of at least one server connected to the theater server.

Still yet another embodiment of the present invention provides a theater server for supporting the playback control of live content videos, the theater server including a central processing unit and a memory, wherein the central processing unit may execute instructions stored in the memory for performing a method for supporting the playback control of live content videos, wherein the method may include a step of providing a second interface for live content video playback control to a user, wherein the second interface may include: a video monitoring area for monitoring a live content video; a log information area for displaying relevant logs when the live content video is played back in the multi-screen theater; and a live content path input area for inputting a live content path.

### Advantageous Effects

According to the present invention, it is possible to easily manage the playback control of multi-screen videos, which requires precise control and sequencing of complex devices.

Moreover, according to the present invention, it is possible to reduce mistakes or malfunctions that may occur during the user's control process, thereby providing high-quality theater services to the audience.

Meanwhile, the above-mentioned effects of the present invention are not limited to those mentioned above, and other technical effects not mentioned will be clearly understood by those skilled in the art from the following description.

### DESCRIPTION OF DRAWINGS

FIG. 1 is a schematic diagram illustrating the control environment in a multi-screen theater that forms the background of the present invention.

FIG. 2 illustrates an example of a first interface provided according to the present invention.

FIG. 3 illustrates the process executed during manual playback control of any content.

FIG. 4 illustrates the addition of any content to sub-screens on a user interface.

FIG. 5 illustrates an example of an interface for controlling the playback of live content videos provided according to the present invention.

FIG. 6 illustrates the configuration of live content video data received by a theater server.

FIG. 7 illustrates a manual playback mode of live content video.

### MODE FOR INVENTION

Details regarding the objects and technical features of the present invention and the resulting effects will be more clearly understood from the following detailed description based on the drawings attached to the specification of the present invention. Preferred embodiments according to the present invention will be described in detail with reference to the attached drawings.

The embodiments disclosed in this specification should not be construed or used as limiting the scope of the present invention. It is obvious to those skilled in the art that the description, including the embodiments, of this specification has various applications. Therefore, any embodiments described in the detailed description of the present invention are illustrative to better illustrate the present invention and are not intended to limit the scope of the present invention to the embodiments.

The functional blocks shown in the drawings and described below are only examples of possible implementations. In other implementations, different functional blocks may be used without departing from the spirit and scope of the detailed description. Moreover, although one or more functional blocks of the present invention are shown as individual blocks, one or more of the functional blocks of the present invention may be a combination of various hardware and software components that perform the same function.

Furthermore, the term “comprising” certain components, which is an “open-ended” term, simply refers to the presence of the corresponding components, and should not be understood as excluding the presence of additional components.

In addition, if a specific component is referred to as being “connected” or “coupled” to another component, it should be understood that it may be directly connected or coupled to another other component, but there may be other components therebetween.

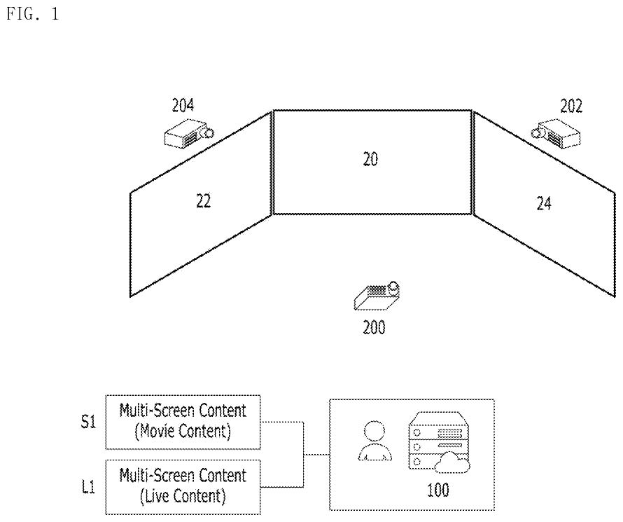

FIG. 1 is a schematic diagram illustrating a multi-screen environment that forms the background of the present invention. Referring to FIG. 1, it is assumed that the multi-screen environment mentioned in the present invention is installed in a multi-screen theater equipped with at least two projection surfaces, preferably including at least a main projection surface 20 in the center and a first sub-projection surface 22 and a second sub-projection surfaces 24 arranged on either side of the main projection surface. Moreover, the multi-screen environment may include projection devices 200, 202 and 204 for projecting videos onto each of the projection surfaces, and a theater server 100 for controlling various equipment and devices within the theater, including these projection devices.

As mentioned above, the present invention relates to a method and system for supporting the playback control of multi-screen videos for users. It is understood that the method for supporting the playback control of multi-screen videos described in this specification can be executed by the theater server 100. In particular, it should be understood that a context-appropriate interface can be provided to support the control tasks of a user, i.e., an administrator, who controls the multi-screen environment through the theater server 100. FIG. 1 illustrates a situation where the theater server 100 receives each piece of content from external content providers, such as a movie content provider server S1 that provides movie content or a live content provider server L1 that provides live content, and plays it back in a multi-screen environment. The present invention aims to provide an intuitive user interface to the user in such a situation to ensure that the movie content or live content is played back correctly.

Meanwhile, unless otherwise specifically stated, it is understood that the method for supporting the playback control of multi-screen videos is executed by the theater server 100; however, it should be understood that this playback control support method may not necessarily be executed solely by a single individual server, but can also be executed by multiple related servers. As used herein, the term “system” is chosen in consideration of the case that there are multiple devices required to implement the playback control support method. To facilitate the understanding of the present invention, the following description will be given on the assumption that the entity executing the playback control support method is a theater server; however, it should be understood that the theater server can also be replaced by a system.

Referring gain to FIG. 1, the main components necessary for implementing the playback control support method according to the present invention, specifically the theater server 100 and the projection devices 200, 202 and 204, will be described in more detail.

The theater server 100 is a computing device that can be operated by a person in charge of managing or operating the theater. It is connected to the main electronic devices in the theater via a network, allowing for control over each electronic device. The theater server 100 according to the present invention can preferably be connected to one or more projection devices via a network, allowing for remote control of the projection devices when control commands are input via the theater server 100. Moreover, the theater server 100 can provide the theater administrator, i.e., the user, with user interfaces for supporting the playback control of content. In this case, the theater server 100 can provide these interfaces to the user either via an output device such as a monitor directly connected to the theater server 100, or through a portable terminal such as a smart phone connected to the theater server 100 via a network.

For reference, it is assumed that the theater server 100 includes a central processing unit and memory. In this case, the central processing unit can also be referred to as a controller, microcontroller, microprocessor, microcomputer, etc. Moreover, the central processing unit can be implemented in hardware, firmware, software, or a combination thereof. When it is implemented using hardware, it can take the form of an application specific integrated circuit (ASIC), a digital signal processor (DSP), a digital signal processing device (DSPD), a programmable logic device (PLD), or a field programmable gate array (FPGA), and when it is implemented using firmware or software, the firmware or software can be configured to include modules, procedures, or functions that perform the above-mentioned functions or operations. Furthermore, the memory can be implemented using a memory such as a Read Only Memory (ROM), Random Access Memory (RAM), Erasable Programmable Read-Only Memory (EPROM), Electrically Erasable Programmable Read-Only Memory (EEPROM), flash memory, Static RAM (SRAM), Hard Disk Drive (HDD), or Solid State Drive (SSD). There is no limitation on the type of hardware required to implement the theater server 100. For example, server computers, portable terminals (laptop computers, smartphones, etc.), desktop computers, etc. are representative examples of computing devices. In addition, in some cases, the theater server 100 can be available in the form of a cloud server.

Next, the projection device 200, 202 and 204 refers to a device for projecting videos, also known as a projector. Multiple projection devices can be installed in a theater, with each projection device positioned to project video onto opposing projection surfaces. The types of projection devices 200 include, but are not necessarily limited to, those implemented with CRT, LCD, and DLP technologies. In the case of multiple projection devices, at least some of the projection devices may be available from different manufacturers based on different principles, and each of the projection devices 200 can be independently connected to the theater server 100 via a network. If necessary, the theater server 100 can cluster several projection devices and control them as a single group; however, each of the projection devices 200, 202 and 204 is fundamentally connected to the theater server 100 independently. In addition, parameters related to content output can be adjusted in the projection device. For example, adjustments can be made to brightness (light source intensity of the projection device), contrast (difference between light and dark), color temperature, focus, zoom, or keystone correction.

As described above, the environment where the multi-screen video playback control according to the present invention is executed, as well as the devices that constitute the same have been discussed with reference to FIG. 1.

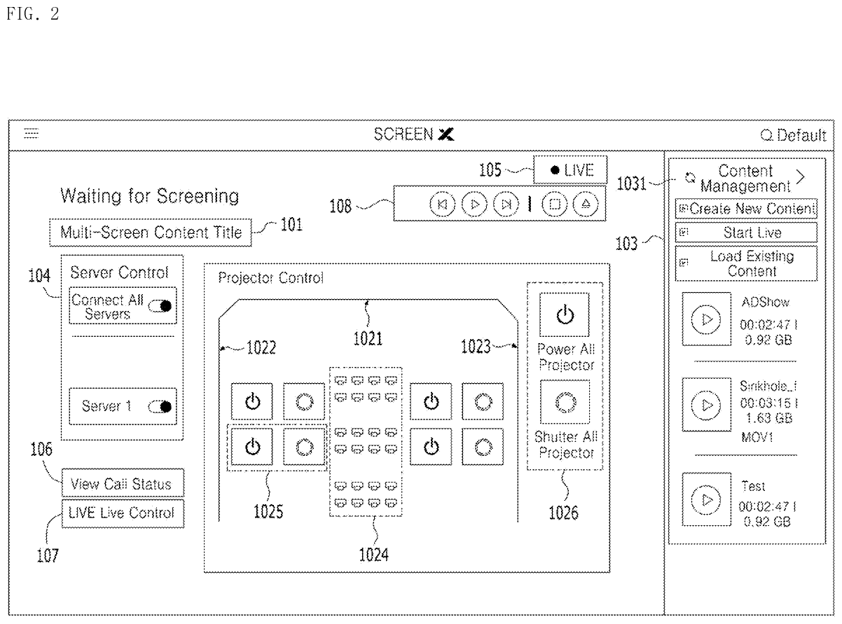

FIG. 2 illustrates an example of a user interface for multi-screen video playback control (hereinafter referred to as the first interface for convenience) provided by the theater server 100 to the user according to the present invention.

Referring to FIG. 2, the first interface may be composed of various areas, specifically including a title area 101, a projection device control area 102 for controlling the projection devices 200 installed in a multi-screen theater, a content area 103 for displaying a list of pieces of multi-screen video content to be played back, and a server control area 104 for controlling the connection with a server (or servers) linked to the theater server 100 via a network.

The title area 101 is an area where the title of the video content currently being played or scheduled to be played is displayed.

The projection device control area 102 is an area that allows the control of power or shutters of the projection devices 200, 202 and 204. The projection device control area 102 can be displayed, as shown in the drawing, to allow the user to intuitively understand the projection surfaces and the projection devices within the theater. Specifically, the projection device control area 102 may include a main projection surface display 1021, a first sub-projection surface display 1022, a second sub-projection surface display 1023, and a seating area display 1024 to allow the user to see the seating arrangement in the multi-screen theater. The user can easily identify the structure of the multi-screen theater by referring to the seating area display and the indicators for each projection surface. Moreover, the projection device control area 102 may include a projection device power or shutter control display 1025 at the location where each projection device is installed, allowing the respective projection devices to be controlled based on a power or shutter control input received from the user. Furthermore, the projection device control area 102 may include a power or shutter control display 1026 for all projection devices, allowing the user to control all projection devices 200, 202 and 204 with a single input.

The content area 103 is an area that displays the content that can be played back on the projection surface(s) within the multi-screen theater, and when a specific piece of content is selected by the user, it may allow access to an interface for checking detailed information about the content or to an interface for modifying the configuration values related to that content. The content displayed in the content area 103 may be video content or image content, and preferably, it may be multi-screen video content or multi-screen image content that can be played back across the multiple projection surfaces. However, the content is not necessarily limited to the aforementioned types and may include content displayed only on a single projection surface (hereinafter referred to as single-screen content for convenience). In some cases, the content displayed in the content area 103 may consist of content that is played back solely on the sub-projection surfaces, rather than the main projection surface. In particular, if the main content provided by an external content server (which may also be referred to as a cinema server) is designed to be played back directly on the main projection surface, the user has no actual control over the main content and thus will only be able to control the content that is played back on the sub-projection surfaces.

In the case of multi-screen content, as shown in the drawing, information such as the content title, content playback time, content size, and the server or slot allocated for the content may be displayed. In the case of single-screen content, in addition to the above information, it may also indicate on which projection surface the content can be displayed.

Meanwhile, the content displayed in the content area 103 can enter either Playback Start or Playback Standby mode based on the user's drag input. For example, if the user drags the first multi-screen video content from the content area 103 into the projection device control area 102, the first multi-screen video content can be set to play back immediately or to stand by for playback. Alternatively, if the user drags a second single-screen video or single-screen image content from the content area 103 into a specific projection surface 1021 to 1023 within the projection device control area 102, it can be set to play back immediately on the specific projection surface or to stand by for playback.

The content area 103 may further include a content management menu 1031, allowing for functions such as creating new content, starting live content, and retrieving existing content. As will be mentioned again later, the content management menu 1031 can be utilized when multi-screen video content is played back in manual screening mode by the user (administrator), while the content management menu 1031 can be configured not to display when the content is played back in automatic screening mode.

The server control area 104 is an area that enables the control of all types of servers connected to the theater server 100. This area can display a list of controllable servers, and buttons for individual control (connection) of each server may be displayed. In addition, there may be a batch server control button that allows for the collective control of all connected servers.

Meanwhile, referring to FIG. 2, the first interface may further include a display 105 that allows the user to check the current connection status of the theater server 100. The connection status of the theater server 100 may refer to the connection status between the theater server 100 and external content servers, or the connection status between the theater server 100 and devices within the theater. As an example, the “LIVE” indicator, denoted by reference numeral 105, may be displayed in bright-colored text when the theater server 100 is linked to an external content server, particularly an external content server providing the content projected on the main projection surface, and is outputting the content in real time. This allows the user to perform theater control tasks while being aware that the theater server 100 is currently projecting movie content in real time.

Furthermore, the first interface may also include a so-called projection area adjustment menu 106 that allows the user to check and adjust how the videos output by the projection devices 200 are displayed onto the projection surfaces within the theater, in other words, whether the projection areas are displayed correctly on the projection surfaces. When the projection area adjustment menu 106 is selected by the user, the theater server 100 can display another interface for checking and adjusting the projection area, allowing the user to manually or automatically adjust the projection area through the interface.

In addition, the first interface may also include a so-called live content control menu 107 that allows for controlling functions specialized for the playback of live content when it is played back within the theater. When the live content control menu 107 is selected by the user, the theater server 100 may display a separate interface for the user. The interface provided to the user upon selection of the live content control menu 107 will be described again with reference to another drawing that will be discussed later.

Additionally, the first interface may further include a playback control menu 108 that allows the user to manipulate functions such as play, stop, fast forward, rewind, repeat, etc. for the multi-screen video content. The playback control menu 108 may be displayed on the first interface only when the multi-screen video content is played back in manual screening mode, while in automatic screening mode, the display of the playback control menu 108 may not be necessary and can be implemented as hidden.

As described above, the first interface for multi-screen video playback control by the theater server 100 to the user has been discussed with reference to FIG. 2.

Meanwhile, the theater server 100 can play back multi-screen video, especially movie content, in two main modes: one is the cue screening mode and the other is manual screening mode. The cue screening mode refers to the process where the theater server 100 is linked to an external content server (cinema server) and receives a cue signal from the content server to initiate the screening. In the cue screening mode, if the multi-screen videos, especially the multi-screen video content to be played back on the sub-projection surfaces, are properly set to standby through the first interface of FIG. 2, the screening can proceed accordingly upon receiving a cue signal from the content server.

The manual screening mode refers to the process where the creation and playback of multi-screen video content is manually performed by the user, i.e., the administrator. The user can execute the manual screening of multi-screen video content through the first interface described above with reference to FIG. 2. For reference, the first interface shown in FIG. 2 illustrates the display appearance when the multi-screen video content is played back in the manual screening mode.

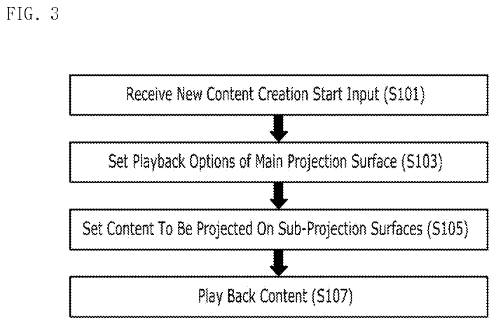

FIG. 3 illustrates the process where the theater server 100 executes manual screening by the user. The process of executing manual screening can be broadly divided into two parts: the process of creating new content and the process of playing back the created content. As used herein, the term “new content” preferably refers to multi-screen video content. Meanwhile, the process of creating new content can also be understood as the process of creating a configuration file that stores the path values and playback configuration values for the content to be screened. For example, this process involves generating a single configuration file that includes the path value for the video to be projected on the first sub-projection surface (left projection surface), the path value for the video to be projected on the second sub-projection surface (right projection surface), and multiple playback configuration values that ensure these videos are played back on the respective projection surfaces. Below, the process of executing the manual screening will be discussed step by step with reference to FIG. 3.

Referring to the drawing, the execution of manual screening can start from receiving a new content creation start input (S101). For example, step S101 can start when the user selects [Create New Content] in the content management menu 1031 of the first interface.

After step S101, a step (S103) for setting the playback options of the main projection surface may be executed. The playback options of the main projection surface may include options such as whether to play back content provided by an external content server (cinema server) or to have the theater server 100 play back content independently, as well as playback options related to the main projection surface, including aspect ratio, resolution, shape of the projection area, brightness, and color tones.

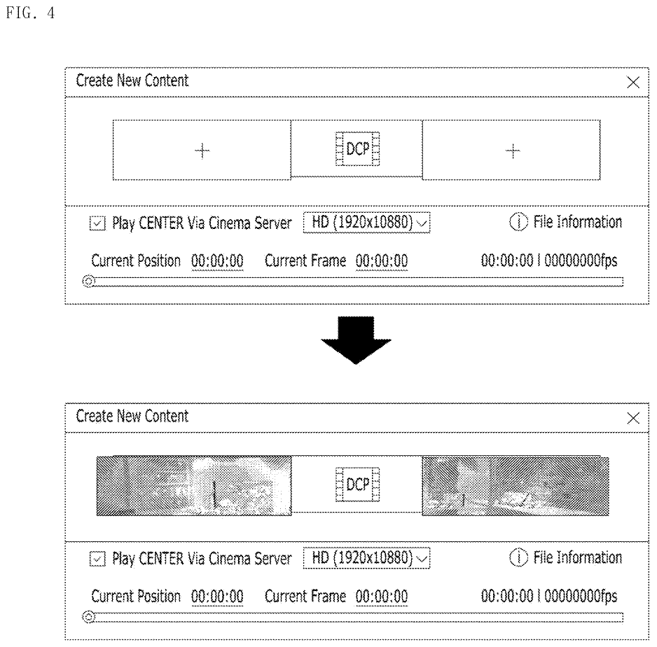

After step S103, a step (S105) for setting the content to be projected on sub-projection surfaces may be executed. This step can be completed by the user clicking on each sub-projection surface and inputting the path values of the videos to be played back on the respective sub-projection surfaces in the interface shown in FIG. 4. FIG. 4 illustrates an example where the user selects a specific sub-projection surface and inputs the video to be played back on that surface, demonstrating the entry of the video's path value. In addition, in the interface shown in FIG. 4, it is possible to simulate how the projection will appear in the actual theater when the video is input to the sub-projection surface.

For reference, step S105 may also include a process where the user directly adds a projection surface. Although not shown in FIG. 4, an editing menu may be provided to allow the user to add a sub-projection surface above, below, to the left, or to the right of the main projection surface. For example, an “Add Sub-Projection Surface” button may be displayed in the up, down, left, and right positions relative to the main projection surface, allowing the corresponding sub-projection surface to be created when the user clicks on it. As another example, the edit menu can list various shapes of projection surfaces (such as rectangular, trapezoidal, elliptical, etc.), and the user can add a sub-projection surface by clicking or dragging a projection surface of the desired shape from the menu to position it around the main projection surface. In this way, step S105 may provide a separate interface and editing menu that allows the user to directly add and position the sub-projection surfaces. After adding the sub-projection surfaces, the user can input the path values for the videos to be played back on the respective sub-projection surfaces.

On the other hand, when a specific video is set for the sub-projection surface in step S105, the theater server 100 can configure the playback configuration values to ensure that the video is correctly output on the sub-projection surface. For example, when a specific video is input to the sub-projection surface, the theater server 100 can execute basic alignment configuration values, such as top alignment and bezel alignment, and store the resulting configuration values as playback configuration values. Additionally, in step S105, the theater server 100 can generate and store multiple playback configuration values for adding videos to the sub-projection surfaces.

Through steps S101 to S105, the user can create new content, which can then be added to the content area 103. Finally, the user can select the content added to the content area 103 to play back the multi-screen video content across multiple projection surfaces (S107).

As described above, the process of executing the manual screening mode has been discussed with reference to FIGS. 3 and 4.

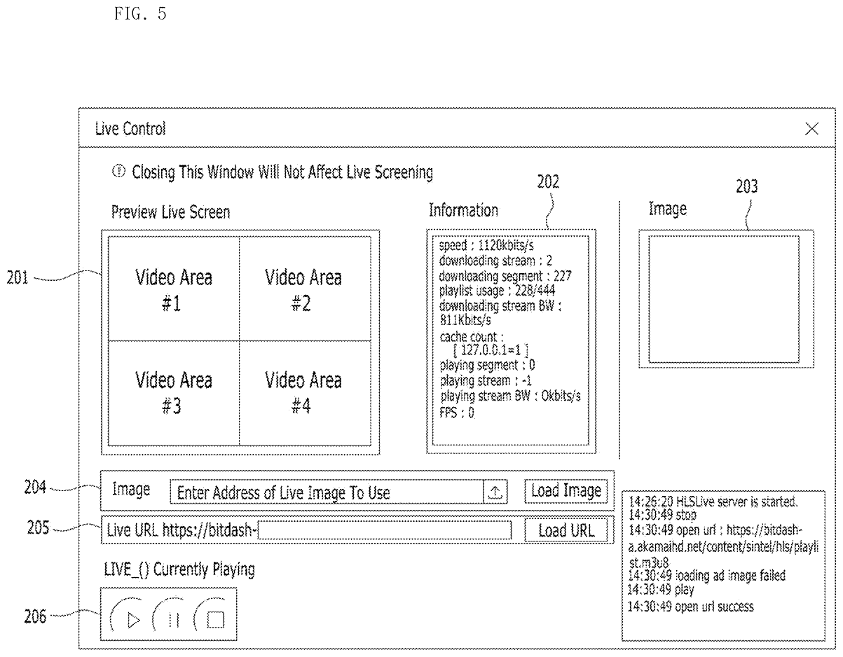

FIG. 5 illustrates an example of an interface for controlling the playback of live content videos (hereinafter referred to as the second interface for convenience), which was previously mentioned. In the early explanation, it was noted that the theater server 100 according to the present invention can play back not only movie content received from an external content server (cinema server) but also live content, such as live performances. The second interface shown in FIG. 5 is provided to the user when trying to play back live content.

Referring to FIG. 5, the second interface may typically include a video monitoring area 201, a log information area 202, an image area 203, an image path input area 204, a live content path input area 205, and a playback control area 206 for controlling the playback of live content videos.

The video monitoring area 201 is an area that displays the live content video itself, received from an external source, or the live content video being projected within the theater, allowing the user to monitor it. In other words, the video monitoring area 201 may serve as a means (first purpose) to verify whether the live content videos received from an external source by the theater server 100 are being received correctly without errors. Alternatively, it may also serve as a means (second purpose) to confirm whether the live content videos received from an external source are being output correctly on each projection surface within the theater. In some cases, both the video monitoring area for the first purpose and the video monitoring area for the second purpose may be displayed within the second interface.

Assuming that the video monitoring area for the first purpose is displayed, the video monitoring area 201 can consist of multiple video areas depending on the number of screens that the live content video is composed of. In the drawing, an embodiment is shown that consists of a total of four video areas.

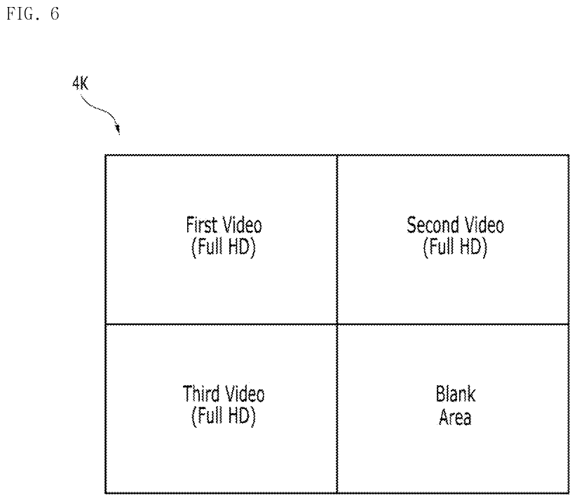

For reference, the theater server 100 receives video data from an external content server (e.g., a server that receives video footage captured directly from a live performance venue), divides multiple videos included in the received video data to correspond to each projection surface, and displays them in the video monitoring area. The video data received from the external content server preferably has a 4K resolution and may be a composite result of Full HD resolution videos combined into one. 4K resolution has four times the number of pixels compared to Full HD resolution, and therefore, up to four videos with Full HD resolution can be combined into a single 4K video data. Three Full HD videos can be generated into one 4K video data as in FIG. 6. The theater server 100 according to the present invention can receive 4K video data as in FIG. 6, divide it into three videos, and display them in the video monitoring area. The three videos correspond to the projection surfaces (main projection surface and sub projection surfaces) provided in the multi-screen theater, respectively. For reference, while it was mentioned that the video data received from the external content server has a 4K resolution and may include four-split Full HD resolution videos, it is also understood that the video data could be implemented to have an 8K resolution, including four-split 4K resolution videos. Additionally, it could also be implemented to include 960×540 resolution videos divided from full HD resolution video data.

As another example, the theater server 100 may receive the aforementioned 4K video data from an external content server (the first content server), and at the same time, receive video data of video footage captured directly at a live performance venue from another external content server (the second content server; e.g., a server installed at a live performance venue), and use the data for the playback of multi-screen video content. In this case, the video monitoring area can display the 4K video (including multiple screens) received from the first content server in video area #4, and multiple videos received from the second content server in video areas #1 to #3. For reference, the theater server 100 can prioritize using the videos received from the second content server for playback within the multi-screen theater, while the videos received from the first content server can be used when needed (e.g., when a data error occurs in any of the videos received from the second content server) by extracting a specific screen area to replace the problematic video.

Referring again to FIG. 5, the second interface may include a log information area 202. The log information area 202 is an area where relevant logs are cumulatively displayed when live content videos are played back within a theater, and logs related to playback, such as Internet speed, download stream, and download segments, may be displayed in real time.

The second interface may also include an image area 203. As used herein, the term “image” may refer to content that is output separately from the video content for purposes such as advertisements or notifications, in addition to the video content played back within the multi-screen theater. Such images can be displayed in the background area of the video or on any other surface within the theater while the live content video is being screened. Meanwhile, the aforementioned image can be loaded into the theater server 100 by the user directly setting the image path through the image path input area 204.

The second interface may further include a live content path input area 205, through which the user can input the source, such as URL information, from which the live content video can be received.

Finally, the second interface may further include a playback control area 206 that the use can manipulate for the playback of the live content video. This area may display buttons that allow the user to start, stop, and pause the playback of the live content video.

As described above, the second interface for controlling the playback of live content videos provided to the user by the theater server 100 has been discussed with reference to FIG. 5.

Meanwhile, it has been previously described that multi-screen videos, especially movie content, can be displayed by the theater server in two modes: automatic screening mode and manual screening mode. In the case of live content video, which can be considered a type of multi-video content, it can be played back in automatic loading playback mode, cue playback mode, and manual playback mode.

Automatic loading playback of live content videos is executed by a single click from the user, covering both the loading and playback of the live content video. For example, if the user clicks on [Start Live] in the content management menu 1031 on the first interface of FIG. 2, the live content video can be automatically played back according to pre-set configuration values. One of the configuration values that must be pre-set in the automatic playback mode is live content path information, i.e., which is input through the area 205 of the second interface. In a preferred embodiment, instead of typing specific values into the live content path input area, the user can select the [Automatic Loading] option to have the live content video be received from the source according to the pre-set values. In another example, if the person managing any content server (which automatically provides live content videos) uploads the corresponding URL value, the URL value can be automatically obtained and set as the live content path information when the user managing a local multi-screen theater selects the [Automatic Loading] option. In this way, in the automatic playback mode of live content videos, the user does not need to directly input the URL value each time, as the live content path can be automatically set in the local theater server 100.

The cue playback mode of live content videos refers to the process of playing back live content videos in response to cue signals received from an external content server (cinema server). The cue signals received from the content server may include a loading cue signal for loading a live content video, a playback cue signal for playing back the live content video, and an ending cue signal for stopping playback. The theater server 100 can play back the live content videos in response to the cue signals received from the content server.

The manual playback mode refers to the process where the user manually inputs the paths for live content videos, the paths for images, etc., before playback.

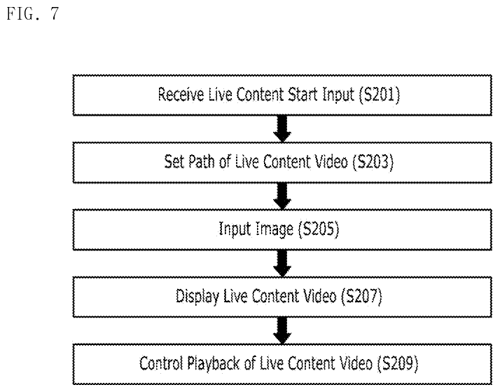

FIG. 7 illustrates the process in which the theater server 100 manually plays back live content videos as performed by the user.

Referring to the drawing, manual playback can begin with the theater server receiving a live content start input (S201). For example, step S201 can be initiated when the user selects [Start Live] from the content management menu 1031.

After step S201, a step (S203) for setting the source (or path) of the live content video may be executed. In this step, the user can directly input a specific URL value or use a separate URL search function provided by the theater server 100 to search for and input the URL value.

After step S203, an image input step (S205) may be executed, during which the user can input the paths where images, such as advertisement images or notification images, are stored.

After step S205, a step (S207) may be executed where the live content video is displayed for video monitoring, followed by a step (S209) where the live content video is played back in response to the user's input. Step S207 is intended to display multiple videos in the video monitoring area 201 of FIG. 5, and step S209 can be understood as the process where the user controls the playback of the video by clicking buttons in the playback control area 206.

As described above, the second interface provided to the user when live content videos are played back by the theater server 100, as well as the playing process, has been discussed with reference to FIGS. 5 to 7.

Meanwhile, the theater server 100 can perform not only the function of screening or playing back multi-screen video content but also the function of monitoring the overall screening or playing process. Notably, the theater server 100 can also report logs generated from the theater server 100 to the central server. The central server refers to a server device that serves to communicate data with each theater server located in multiple local multi-screen theaters and manages the respective local theaters. The theater server in each local theater can be designed to transmit log records regarding any abnormalities either immediately or periodically to the central server. Upon receiving these log records, the central server can notify the administrator about which theater is experiencing problems or inform the affected theater on how to respond to the problems. Furthermore, if a specific program on the theater server 100 is terminated abnormally, particularly a program responsible for playing back multi-screen video content (the program providing the aforementioned first and second interfaces), a reporting file can be created and stored in a specific path within the theater server. This reporting file can be shared with the central server simultaneously upon its creation and storage. The event of the content playback software terminating abnormally on the theater server is critically detrimental to theater operations. Therefore, it is necessary to cumulatively manage information regarding why such abnormal terminations occur and under what circumstances. In this regard, the theater server 100 according to the present invention can be implemented to create and share reporting files as described above, for the purpose of analyzing problems and securing solutions.

As above, the method and system for supporting the playback control of multi-screen videos have been discussed. Meanwhile, the present invention is not limited to the specific embodiments and applications described above, and various modifications can be made by those skilled in the art without departing from the gist of the present invention as claimed in the claims. These modified implementations should not be understood as being separate from the technical spirit or scope of the present invention.

1. A method for supporting the playback control of multi-screen videos by a theater server in a multi-screen theater including multiple projection surfaces, the method comprising a step of providing a first interface for multi-screen video playback control to a user,
wherein the first interface comprises:
a title area for displaying the title of multi-screen video content that is currently being played or scheduled to be played;
a projection device control area for controlling multiple projection devices provided in the multi-screen theater;
a content area for displaying at least one piece of content that can be played back in the multi-screen theater; and
a server control area that allows control of at least one server connected to the theater server.

2. The method for supporting the playback control of multi-screen videos according to claim 1, wherein the projection device control area comprises:
a display indicating a main projection surface and multiple sub-projection surfaces; and
a display indicating the seating arrangement in the multi-screen theater.

3. The method for supporting the playback control of multi-screen videos according to claim 1, wherein the multi-screen video content displayed by the theater server is played back in cue screening mode or manual screening mode.

4. The method for supporting the playback control of multi-screen videos according to claim 3, further comprising, if the multi-screen video content is played back in manual screening mode by the theater server,
a step of receiving a new content creation start input from the user through the first interface;
a step of setting playback options of the main projection surface within the multi-screen theater;
a step of setting the content to be projected on the sub-projection surfaces within the multi-screen theater; and
a step of creating new content.

5. A method for supporting the playback control of live content videos by a theater server in a multi-screen theater including multiple projection surfaces, the method comprising a step of providing a second interface for live content video playback control to a user,
wherein the second interface comprises:
a video monitoring area for monitoring a live content video;
a log information area for displaying relevant logs when the live content video is played back in the multi-screen theater; and
a live content path input area for inputting a live content path.

6. The method for supporting the playback control of live content videos according to claim 5, wherein
the second interface may further comprises an additional video monitoring area for monitoring whether the live content video is being output normally across the multiple projection surfaces within the multi-screen theater.

7. The method for supporting the playback control of live content videos according to claim 5, wherein the live content video is obtained from live content video data received by the theater server from any content server, and
wherein the live content video data is a composite video composed of multiple videos corresponding to each projection surface within the multi-screen theater.

8. The method for supporting the playback control of live content videos according to claim 5, wherein the second interface further comprises an image area for displaying a specific image that is output separately from the live content video within the multi-screen theater.

9. The method for supporting the playback control of live content videos according to claim 8, wherein the specific image is an advertising image or a notification image that is output on a specific projection surface within the multi-screen theater or in an area other than the projection surface.

10. The method for supporting the playback control of live content videos according to claim 8, wherein the second interface further comprises an image path input area for inputting the path of the specific image.

11. The method for supporting the playback control of live content videos according to claim 5, wherein the live content video displayed by the theater server is played back in any one of automatic loading playback mode, cue playback mode, or manual playback mode.

12. The method for supporting the playback control of live content videos according to claim 11, further comprising, if the live content video is played back in manual playback mode by the theater server,
a step of receiving a live content start input from the user through the second interface; and
a step of setting the path of the live content video to be played back in the multi-screen theater.

13. A theater server for supporting the playback control of multi-screen videos, the theater server comprising a central processing unit and a memory,
wherein the central processing unit executes instructions stored in the memory for performing a method for supporting the playback control of multi-screen videos,
wherein the method for supporting the playback control of multi-screen videos comprises a step of providing a first interface for multi-screen video playback control to a user,
wherein the first interface comprises:
a title area for displaying the title of multi-screen video content that is currently being played or scheduled to be played;
a projection device control area for controlling multiple projection devices provided in the multi-screen theater;
a content area for displaying at least one piece of content that can be played back in the multi-screen theater; and
a server control area that allows control of at least one server connected to the theater server.

14. A theater server for supporting the playback control of live content videos, the theater server comprising a central processing unit and a memory,
wherein the central processing unit executes instructions stored in the memory for performing a method for supporting the playback control of live content videos,
wherein the method comprises a step of providing a second interface for live content video playback control to a user,
wherein the second interface comprises:
a video monitoring area for monitoring a live content video;
a log information area for displaying relevant logs when the live content video is played back in the multi-screen theater; and
a live content path input area for inputting a live content path.
